(19) United States
(12) Patent Application Publication
(10) Pub. No.: US 2025/0262796 A1
(43) Pub. Date: Aug. 21, 2025

(54) CERAMIC COMPONENT, CERAMIC/METAL COMPONENT, MANUFACTURING METHOD THEREFOR AND APPLICATIONS THEREOF

(71) Applicant: City University of Hong Kong Shenzhen Futian Research Institute, Shenzhen (CN)

(72) Inventors: Jian LU, Shenzhen (CN); Guo LIU, Shenzhen (CN); Zhifeng ZHOU, Shenzhen (CN); Xiaofeng ZHANG, Shenzhen (CN); Xinya LU, Shenzhen (CN)

(21) Appl. No.: 19/191,921

(22) Filed: Apr. 28, 2025

Related U.S. Application Data
(63) Continuation-in-part of application No. 18/182,317, filed on Mar. 10, 2023.

(30) Foreign Application Priority Data
Feb. 10, 2023 (CN) 202310152026.7

(51) Int. Cl. B28B 1/00; B28B 11/12; B28B 11/24; B33Y 10/00; B33Y 40/20; B33Y 70/10; B33Y 80/00; C04B 35/571; C04B 41/00; C04B 41/50; C04B 41/87

(52) U.S. Cl. CPC B28B 1/001; B28B 11/12; B28B 11/24; C04B 35/571; C04B 41/009; C04B 41/5031; C04B 41/87; B33Y 10/00; B33Y 40/20; B33Y 70/10; B33Y 80/00; C04B 2235/6026; C04B 2235/612; C04B 2235/6562; C04B 2235/6567; C04B 2235/77; C04B 2235/94; C04B 2235/9615; C04B 2235/963

(57) ABSTRACT

This invention applied a paradigm for the one-step-shape/material-transformation, high-2D/3D/4D-precision, high-efficiency, and scalable in situ 4D additive-subtractive manufacturing of ceramics in aerospace fields. The printed ceramics exhibited a high flame ablation performance with the integration of 2D printing (ALD) and 3D/4D printing of ceramic materials. The proposed paradigm can be extended to other high-temperature materials to build ceramic/metal composite structures.

### CROSS-REFERENCE TO REPLATED APPLICATIONS

The present application is a continuation-in-part of U.S. patent application Ser. No. 18/182,317, filed on Mar. 10, 2023, which claims the priority of the prior application No. 202310152026.7 submitted to China National Intellectual Property Administration on Feb. 10, 2023, which is entitled “ceramic component or ceramic/metal components, manufacturing method therefor and applications thereof”, the content of each is incorporated herein by reference in its entirety.

### TECHNICAL FIELD

The present disclosure belongs to the technical field of ceramics, concerns a ceramic component or a ceramic/metal component and a manufacturing method therefor and applications thereof, and particularly concerns a ceramic component or a ceramic/metal component, and a 2D/3D/4D additive-subtractive manufacturing method thereof and applications thereof in aerospace and other fields.

### BACKGROUND

The development of high-temperature structural materials is limited by their extremely high melting points and the challenging processes involved in building complicated architectures. The evolution of printable polymeric precursor materials has facilitated the emergence of 3D printing technologies for high-temperature materials such as ceramics, glass, and metals. Four-dimensional (4D) printing has helped enhance the geometrical flexibility of ceramics. However, the existing ceramic 4D printing systems are limited by a number of the following factors: the separate processes required for shape and material transformations, low accuracy of morphing systems, low resolution of ceramic structures, and time-intensive nature. Furthermore, SiOC is not a good material for the applications at temperatures above 1200° C., because it is amorphous and softens at temperatures above 1200° C. Novel materials and methods need to be developed to solve the thermal performance of SiOC-based ceramic material systems for 3D/4D additive-subtractive manufacturing in aerospace and other high-temperature applications.

### SUMMARY

In view of the state of the prior art, the present disclosure provides a novel method for manufacturing a ceramic component or a ceramic/metal component, and provides a ceramic component or a ceramic/metal components manufactured by the method, the component being particularly suitable for applications in aerospace and other high-temperature fields. Specifically, the present disclosure provides the following scheme:

Provided is a method for manufacturing a ceramic component or a ceramic/metal component, comprising:
1) constructing a heterogeneous object; and
2) converting the heterogeneous object into a ceramic or a ceramic/metal object.

According to the present disclosure, the step 1) specifically comprises at least one of the following modes:
a. Mode 1, comprising:
1-1) manufacturing or preparing a ceramic precursor material capable of forming a ceramic object; and
1-2) constructing a heterogeneous precursor or object;
b. Mode 2, comprising:
1-1′) manufacturing or preparing a ceramic precursor material and a metal precursor material capable of forming a ceramic/metal component; and
1-2′) constructing a heterogeneous precursor object; and
c. Mode 3, comprising:
1-1″) manufacturing or preparing a ceramic precursor material and a metal object capable of forming a ceramic/metal component; and
1-2″) constructing a ceramic precursor object, and combining the ceramic precursor object with a metal object to obtain a heterogeneous object.

The present disclosure also provides a method for manufacturing a ceramic/metal component, which comprises one of the following two modes:

Mode I, comprising:
Ia) manufacturing or preparing a ceramic-based object and a metal object, respectively; and
IIa) manufacturing a ceramic/metal component from the ceramic-based object and the metal object in the step Ia); and

Mode II, comprising:
Ib) preparing a ceramic-based object; and
IIb) then casting a metal material into a structure of the ceramic-based object, and assembling the metal material and the ceramic-based object to manufacture a ceramic/metal component. The present disclosure also provides a ceramic component or a ceramic/metal component manufactured by the method described above.

The present disclosure also further provides applications of the ceramic component or the ceramic/metal component, which is applied to the aerospace or other high-temperature fields; in particular, it can be applied to aerospace turbine blades or blisk, morphing thermal protection systems, space origami systems, on-orbit manufacturing and repair, or in situ space printing and colonization. Other systems, methods, and features of the present disclosure become apparent to those of ordinary skill in the art upon examination of the following drawings and detailed description. It is intended that all such additional systems, methods, and features be included within this specification and be within the scope of the present disclosure.

### Beneficial Effects of Present Disclosure

The present disclosure provides a method for manufacturing a ceramic component or a ceramic/metal component, which relates to a novel paradigm involving the one-step shape/material transformation of ceramics from noncontact stimuli and synergies between the manufacturing speed, resolution, and scalability, and effectively promotes the further evolution of ceramic 4D printing in the aerospace and other high-temperature fields. Specifically, the present disclosure broadens the applications of ceramic and ceramic/metal components in the aerospace and other high-temperature fields, and mainly including all-ceramic aerospace turbine blisk, morphing thermal protection systems, space origami systems, on-orbit manufacturing and repair, in situ space printing and colonization.

Specifically, the present disclosure provides a paradigm for in situ 4D additive-subtractive manufacturing of ceramics in aerospace fields, wherein the manufacturing process has the characteristics of e one-step-shape/material-transformation, high 2D surface quality, high 3D structural resolution, high 4D morphing precision, high efficiency, and high scalability.

According to the present disclosure, a ceramic coating material is further deposited on the surface of 3D/4D printed ceramic structures, so that the ceramics with complex structures exhibit relatively high flame ablation performance. The proposed paradigm can be extended to other high-temperature materials.

The method proposed in the present disclosure can ensure high scalability (16 cm), high resolution (6 μm), ultrafast transformation to high-temperature materials (in several seconds), and rapid manufacturing of precursor materials (mass production capability).

The present disclosure develops the concept of 2D/3D/4D precursor polishing with versatile high-energy beam and mechanical grinding tools for the first time, and high-surface-quality and high-temperature materials can be obtained.

Furthermore, the proposed paradigm can be applied to ceramics, glass, metals and composite materials; the present disclosure also provides at least four different methods for achieving 3D/4D printing/manufacturing of ceramic/metal composite structures for the first time, unlike existing strategies that are typically limited to only one or two types of high-temperature materials. Therefore, the research can broaden the application scope of the high-temperature structural materials in aerospace and other high-temperature fields.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings are included to provide a further understanding of the present disclosure, and are incorporated in and constitute a part of this specification. The components in the drawings are not necessarily to scale, but emphasize clearly illustrating principles of the embodiments of the present disclosure. The drawings illustrate the embodiments of the present disclosure and together with the description serve to explain the principles of the present disclosure.

FIG. 1 shows schematic of 4D printing and integrated shaping for a ceramic blisk.

FIG. 2 shows video of shape and material transformations of 4D printing and integrated shaping for the all-ceramic blisk, Definitions of important geometric parameters: d1=2 mm; d2=1 mm; d3=1.1 mm; α=55°.

FIG. 3 shows 4D printing and integrated shaping for large-scale and complex-shaped ceramic blisks and blades.

FIG. 3 panel a and panel b show Precursor material of whole (panel a) and sectional (panel b) blisks with a mask for local UV and ozone exposure.

FIG. 3 panel c and panel d show 4D printed ceramic blisk with a scalability as large as 16 cm (panel c) and 13 cm (panel d).

FIG. 3 panel e shows flat and twisted (origami) sectional turbine blades with complex-shaped cooling channel structures.

FIG. 4a to FIG. 4e show 2D/3D/4D precursor polishing.

FIG. 4a shows precursor polishing strategy.

FIG. 4b shows the PLE method was used for polishing a printed flat ceramic precursor material with the stair-step effect.

FIG. 4c shows mechanical grinding was performed for polishing a printed ceramic precursor material with a hyper-hemispherical dome structure, resulting in surface polishing of 3D printed ceramic structures through polymer-to-ceramic transformation.

FIG. 4d shows 4D printing and integrated shaping for a large-scale all-ceramic blisk with lightweight designs.

FIG. 4e shows 4D printing for polishing complex-shaped ceramic blades with curved surfaces, and shows diagrams of scanned surfaces of the 4D printed ceramic sample of FIG. 4e after mechanical grinding, raw printing, and laser polishing respectively with the comparison of surface roughness thereof.

FIG. 5 shows 3D precursor polishing of a hyper-hemispherical dome structure.

FIG. 6 shows additive-subtractive manufacturing (ASM) system based on precursor polishing.

FIG. 7 shows thermal performance of printed ceramic materials, panel a to panel c, SEM images of Al₂O₃-deposited ZrO₂—SiOC ceramic lattice; panel d to panel f, SEM images of Al₂O₃-deposited AlON—SiOC ceramic lattice; panel g, flame ablation testing; panel h, comparison of flame ablation performance at 1400° C. for 1 minute; panel i, sample status of Al₂O₃-deposited ZrO₂—SiOC NCADP ceramic lattices before and after flame ablation testing at 1500° C. for 1 minute.

FIG. 8 shows NCADP structure of printed ZrO₂—SiOC ceramic lattice, wherein panel a, TEM image; panel b, high-resolution TEM image; panel c, SAED results; panel d, EDS mapping analysis; panel e, EDS line scan analysis and curves of net intensity and intensity of elements at different positions.

FIG. 9 shows NCADP structure of printed AlON—SiOC ceramic lattice, wherein panel a, TEM image; panel b, high-resolution TEM image; panel c, SAED result; panel d, EDS mapping analysis; panel e, EDS line scan analysis and curves of net intensity and intensity of elements at different positions.

FIG. 10 shows amorphous Al₂O₃ formed on the surface of a silicon wafer with ALD technology. Panel a. high-resolution TEM image and fast Fourier transform result (inset). Panel b. EDS mapping analysis.

FIG. 11 shows SEM analysis of Al₂O₃-deposited ZrO₂—SiOC ceramic lattices. Panel a and panel b, SEM images of the cross-section. Panel c and panel d, EDS line analysis.

FIG. 12 shows SEM analysis of Al₂O₃-deposited AlON—SiOC ceramic lattices. Panel a and panel b, SEM images of the cross-section. Panel c and panel d, EDS line analysis.

FIG. 13 shows flame ablation testing samples of ZrO₂—SiOC NCADP ceramic lattice with/without Al₂O₃ deposition in FIG. 7.

FIG. 14 shows flame ablation testing samples of AlON—SiOC NCADP ceramic lattice with/without Al₂O₃ deposition in FIG. 7.

FIG. 15 shows flame ablation testing samples of IN718 alloy lattice and bulk IN718 alloy with TBC in FIG. 7.

FIG. 16 shows 4D printed ceramic/metal composite structure.

FIG. 17 shows schematic of manufacturing ceramic/metal composite structures for aerospace application in the turbine blade. Wherein panel a, assembly of printed ceramic precursor coatings and Ni-based alloy turbine blade by wrapping. Panel b, assembly of printed ceramic coatings and Ni-based alloy turbine blade by wrapping. Panel c, casting of Ni-based alloy into printed ceramic turbine blade.

FIG. 18 shows application perspectives of 2D/3D/4D additive-subtractive manufacturing of ceramic and ceramic/metal components for aerospace applications, including all-ceramic aerospace turbine blisk, morphing thermal protection systems, space origami systems, on-orbit manufacturing and repair, and in situ space printing and colonization.

### DETAILED DESCRIPTION

### [Method for Manufacturing Ceramic or Ceramic/Metal Components-Precursor Materials Involved]

As described above, the present disclosure discloses a method for manufacturing a ceramic component or a ceramic/metal component, which comprises:
1) constructing a heterogeneous object; and
2) transforming the heterogeneous object into a ceramic or a ceramic/metal object.

In the present disclosure, the term “the heterogeneous object” refers to an object including at least two different structures and/or compositions.

In some embodiments of the present disclosure, the step 1) may specifically comprise at least one of the following modes:

Mode 1, comprising:
1-1) manufacturing or producing a ceramic precursor material capable of forming a ceramic component; and
1-2) constructing a heterogeneous precursor object;
b. Mode 2, comprising:
1-1′) manufacturing or preparing a ceramic precursor material and a metal precursor material capable of forming a ceramic/metal component; and
1-2′) constructing a heterogeneous precursor object; and
c. Mode 3, comprising:
1-1″) manufacturing or preparing a ceramic precursor material and a metal object capable of forming a ceramic/metal component; and
1-2″) preparing a ceramic precursor object, and combining the ceramic precursor object with a metal object to obtain a heterogeneous object.

In the present disclosure, the ceramic component or the ceramic/metal component in the step 2) is a kind of components having high precision and a complex shape.

### [Precursor Materials]

In some embodiments of the present disclosure, in the step 1-1), the step 1-1′) and the step 1-1″), the ceramic precursor material may be selected from a polymer, or a polymer composite consisting of polymer matrix and fillers.

In some embodiments of the present disclosure, in the step 1-1), the step 1-1′) and the step 1-1″), the ceramic precursor material may be selected from a polymer, wherein the polymer may be selected from poly(dimethylsiloxane) (PDMS) or silicone; or the ceramic precursor material may be selected from a polymer composite consisting of polymer matrix and fillers, wherein the polymer matrix may be selected from poly(dimethylsiloxane) (PDMS) or silicone. In some embodiments of the present disclosure, in the step 1-1′), the metal precursor material comprises a polymer, or a polymer composite consisting of polymer matrix and metal fillers.

In some embodiments, the polymers or polymer matrix include silicone materials, cellulose, or combinations thereof.

In some embodiments, the filler comprises a ceramic material, or a metal material, or combination thereof, and the fillers comprise powders, fibers, whiskers, plates, or combinations thereof. Illustratively, the ceramic material comprises ZrO₂, AlON, AlN, Al₂O₃, SiC, Si₃N₄, or a combination of two or more thereof; illustratively, the metal material comprises at least one of Fe or other metal materials.

In some embodiments, the metal filler comprises ZrO₂, AlON, AlN, Al₂O₃, SiC, Si₃N₄, or combinations thereof, and at least one of Fe or other metal materials.

In some embodiments, the composite material is manufactured after the polymer matrix is mixed with the filler.

### [Construction of Precursor Object]

In some specific embodiments, in the step 1-2), the step 1-2′) and the step 1-2″), the precursor object is manufactured using an additive manufacturing process;
or, the precursor object is manufactured by an additive manufacturing process in combination with at least one of the following processes: a subtractive manufacturing process and a surface engineering process.

In some specific embodiments, the additive manufacturing process includes extrusion printing, blade coating, or a combination thereof. Specifically, the material used in the additive manufacturing process is a ceramic precursor, a metal precursor, or a combination thereof.

In some specific embodiments, in the step 1-2), the step 1-2′) and the step 1-2″), the precursor object is obtained by 2D printing or 3D printing using an ink system (specifically, a well-designed ink systems).

In some specific embodiments, the subtractive manufacturing process includes engraving, cutting, surface polishing, or a combination thereof.

Specifically, the surface polishing includes 2D polishing, 3D polishing, 4D polishing, or a combination thereof.

Specifically, in the step 1-2), the step 1-2′) and the step 1-2″), the surface polishing is integrated with an additive manufacturing process to form an additive-subtractive manufacturing system for a ceramic component or a ceramic/metal component.

Specifically, a tool used in the subtractive manufacturing process comprises high-energy beam, mechanical grinding tools, or combinations thereof. Illustratively, the high-energy beam comprises a laser beam, a water beam, or a combination thereof.

In some specific embodiments, the surface engineering process includes ultraviolet and ozone exposure, physical vapor deposition, chemical vapor deposition, atomic layer deposition, or a combination thereof.

Specifically, the ultraviolet and ozone exposure area may be locally adjusted.

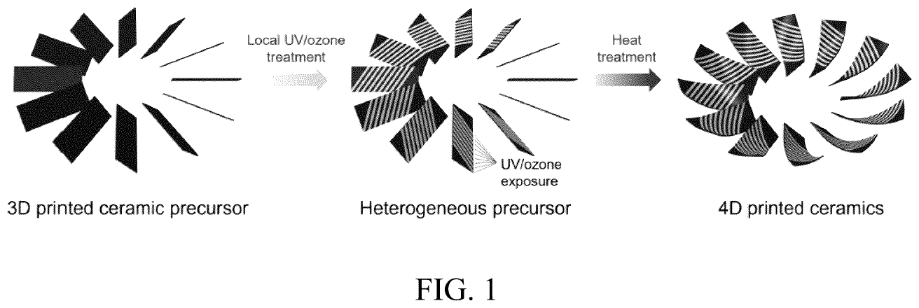

In some specific embodiments, in the step 1-2), the step 1-2′) and the step 1-2″), a combination of additive manufacturing and surface engineering can be employed to construct the precursor object. As shown in FIG. 1, a ceramic precursor is firstly obtained by 3D printing, and then subjected to overall or local ultraviolet and ozone exposure to obtain a heterogeneous precursor object (furthermore, as shown in FIG. 1, the heterogeneous precursor object can be further subjected to heat treatment to obtain a 4D printed ceramic component).

During the ultraviolet and ozone exposure, the polymer (such as PDMS) on the surface of the portions which are exposed to the ultraviolet and ozone undergoes a chemical reaction, while the polymer on the surface of the portions which are not exposed to the ultraviolet and ozone remains unchanged (such as, still is PDMS), thus obtaining a heterogeneous object.

The wavelength of the ultraviolet may be 10-400 nm, preferably 100-350 nm, most preferably 170-270 nm.

The concentration of the ozone may be 10-10,000 ppm, preferably 50-5,000 ppm, more preferably 100-1,000 ppm, most preferably 200-300 ppm.

The time of the ultraviolet and ozone exposure may be 1-40 hours, preferably 2-30 hours, more preferably 3-20 hours, most preferably 8-16 hours. The precursors were 3D printed using well-designed ink systems, and subtractive manufacturing techniques with a high-energy beam (e.g., laser beam) can enhance the manufacturing precision, resulting in a high-resolution additive-subtractive manufacturing system.

In some specific embodiments, the 3D printed precursors were laser engraved or cut using the optimal laser scanning strategy pertaining to a certain laser scanning power and speed and subjected to heat treatment to obtain high-temperature structural materials. With the invention of novel precursor material systems and precursor laser engraving/cutting (PLE/PLC) methods, the machining processes of high-temperature materials have become cost-efficient and environmentally friendly with high-resolution capacities. Based on ASM, a paradigm for precise, scalable, and rapid in situ 4D printing of high-temperature materials has been developed by tuning the heterogeneous precursors. The rapid one-step shape/material transformation of heterogeneous structural precursors was realized in a heating furnace. Owing to the different thermal expansion and shrinkage behaviors of heterogeneous structural precursors, the ceramic precursor was transformed in terms of both the shape and material components when subjected to thermal treatment (FIG. 1).

The laser machining technique is used to generate high-resolution features and tune the stiffness of the structures. Next, a thin film is created on the surface of the sample, and the film thickness is tuned by changing the processing time in an ultraviolet (UV) and ozone system. The sample is then subjected to heat treatment in inert gas or vacuum conditions. The thermal expansion and shrinkage behaviors of the 2D UV and ozone film material and 3D printed precursor material are different, and this heterogeneity leads to shape transformation of the precursor structures.

In some specific embodiments, Mode 3 specifically comprises: firstly, preparing a metal object and a ceramic precursor object, and the two objects having different textures; and then assembling the metal object and the ceramic precursor object to obtain a heterogeneous object.

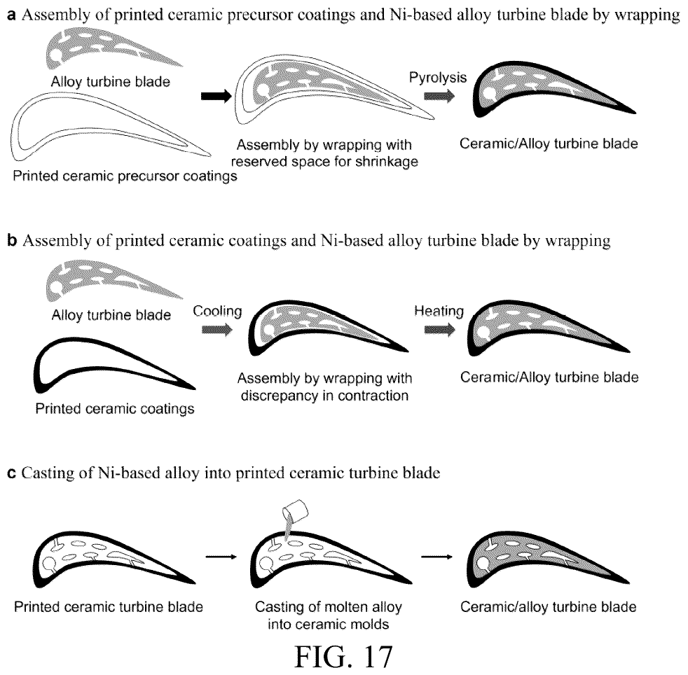

In some embodiments, in Mode 3, an assembly of the printed ceramic precursor coating and the metal structure is achieved by wrapping; still specifically, the assembly of the printed ceramic precursor coating and the metal structure (such as a nickel-based alloy turbine blisk) by wrapping is achieved by adjusting a reserved space for the shrinkage effect in the process of converting the precursor into the ceramic, namely, the assembly is achieved by reserving a shrinkage space. Also specifically, as shown in FIG. 17 panel a, a metal object (such as a nickel-based alloy turbine blisk) and a ceramic precursor object (such as a 3D printed ceramic precursor coating) obtained by an additive manufacturing process are prepared and assembled to obtain a precursor object having a heterostructure (metal/ceramic composite structure) according to the present disclosure.

[Conversion of Heterogeneous Object into Ceramic Component or Ceramic/Metal Component]

In some specific embodiments, there is 4D morphing in the step 2).

In some specific embodiments, in the step 2), the ceramic or the ceramic/metal object may be obtained by heat treatment.

In some specific embodiments, in the step 2), the ceramic or the ceramic/metal object may be obtained by 4D printing. For the ceramic object, the temperature of the heat treatment may be 600-2000° C., preferably 800-1600° C.; the heat treatment time may be 0.5-10 hours, preferably 1-5 hours. The heating rate may be 1-1000° C./min, preferably 1-15° C./min. The heat treatment may be carried out under vacuum or an inert atmosphere, and the inert atmosphere may be, for example, nitrogen or argon, etc. After the heat treatment, the object is cooled to the ambient temperature. The cooling rate may be 1-100° C./min, preferably 1-15° C./min.

### [4D Morphing Precision]

In situ 4D printing can achieve geometrical flexibility and high morphing precision for advanced structural ceramics and can be used in high-temperature applications such as aerospace propulsion.

### [Hybrid Manufacturing System of Local UV and Ozone Exposure, Additive Manufacturing Process, and 4D Printing]

In a specific embodiment, through local UV and ozone exposure, 12 blades with flat surfaces were simultaneously programmed to achieve twisting deformations with a high repeatability, resulting in a flower-like symmetrical structure.

In a specific embodiment, the following heat treatment process is used: heating the manufactured heterogeneous ceramic precursor to 1000° C. for 2 hours in a heating furnace under vacuum, and then cooling to the ambient temperature; wherein the heating and cooling rates are 5° C. min⁻¹ and 10° C. min⁻¹, respectively.

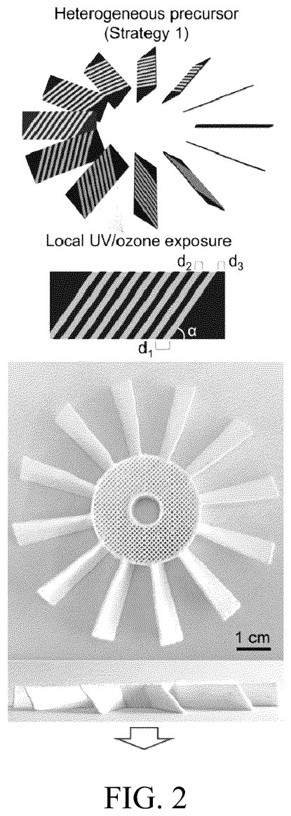

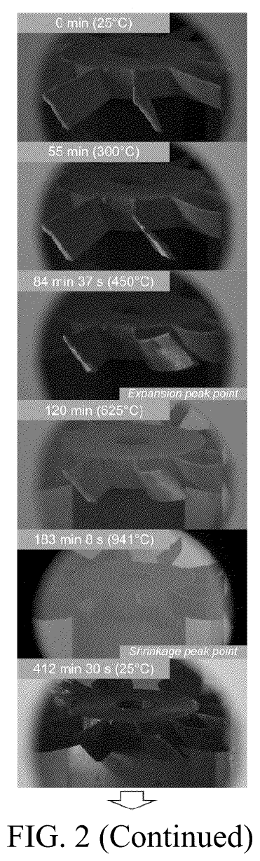

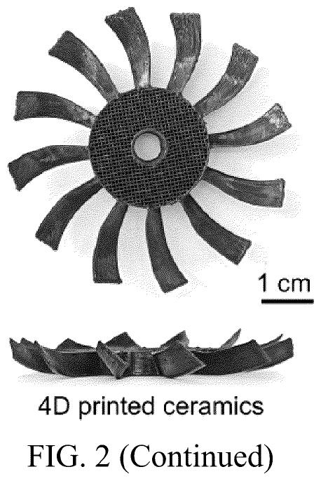

With the use of the method of the present disclosure, the ceramic engine turbine disk and 12 blades are in situ 4D printed as a single piece without the need for an assembly process (see FIG. 2).

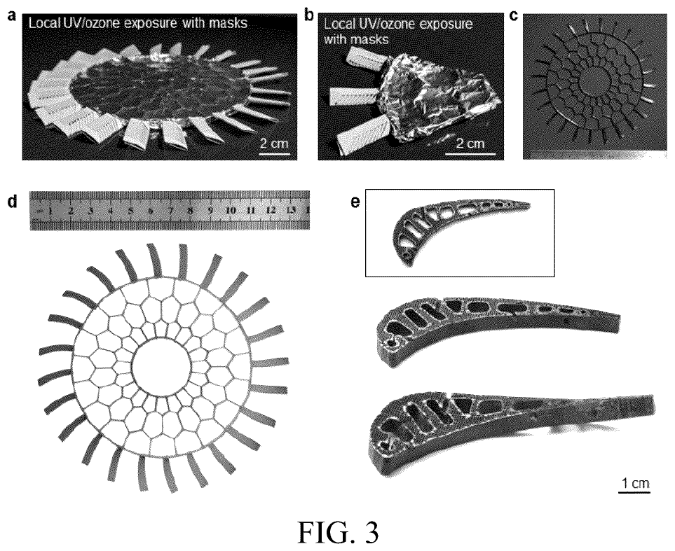

The concept of in situ 4D printing and integrated shaping for the all-ceramic aerospace turbine bladed disk (blisk) is a valuable route for developing advanced and intelligent aerospace propulsion components with a high system efficiency, low lifecycle cost, and decreased environmental pollution. First, the proposed in situ 4D printing technique for high-temperature materials overcomes the limitations typically encountered in fabricating geometrically complex large-scale (as large as 16 cm) propulsion components with topologically lightweight designs by using conventional wrought, casting, welding, and subtractive manufacturing (FIG. 3).

FIG. 3 shows 4D printing and integrated shaping for large-scale and complex-shaped ceramic blisks and blades, wherein FIG. 3 panel a is a precursor object of the whole blisk with a mask for local UV and ozone exposure; FIG. 3 panel b is a precursor object of the sectional blisk with a mask for local UV and ozone exposure; FIG. 3 panel c is a 4D printed ceramic blisk with a scalability as large as 16 cm; FIG. 3 panel d is a 4D printed ceramic blisk with a scalability as large as 13 cm; FIG. 3 panel e is printed flat and twisted (origami) sectional turbine blades with complex-shaped cooling channel structures composed of a ceramic material, in which the twisted (origami) one is converted from a precursor in a twisted (origami) state.

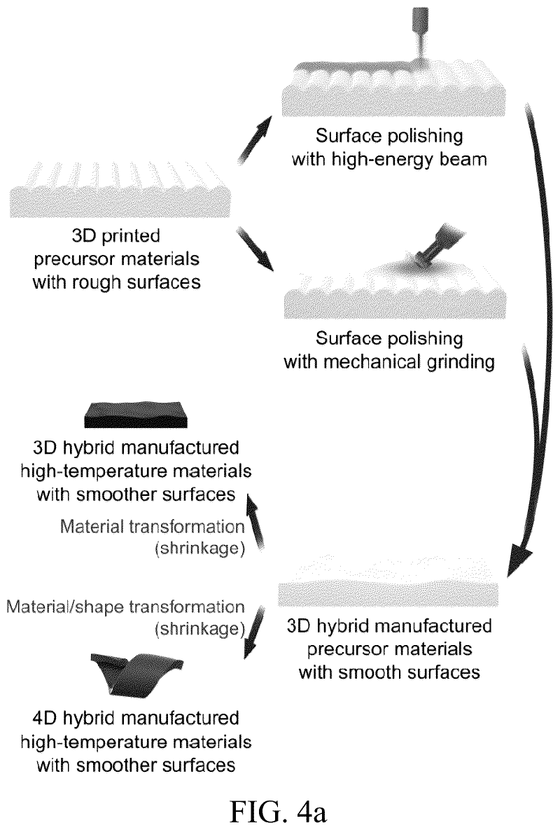

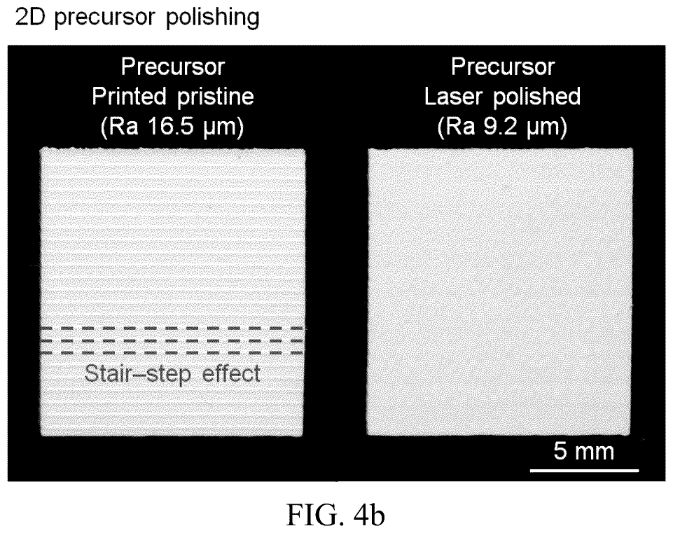

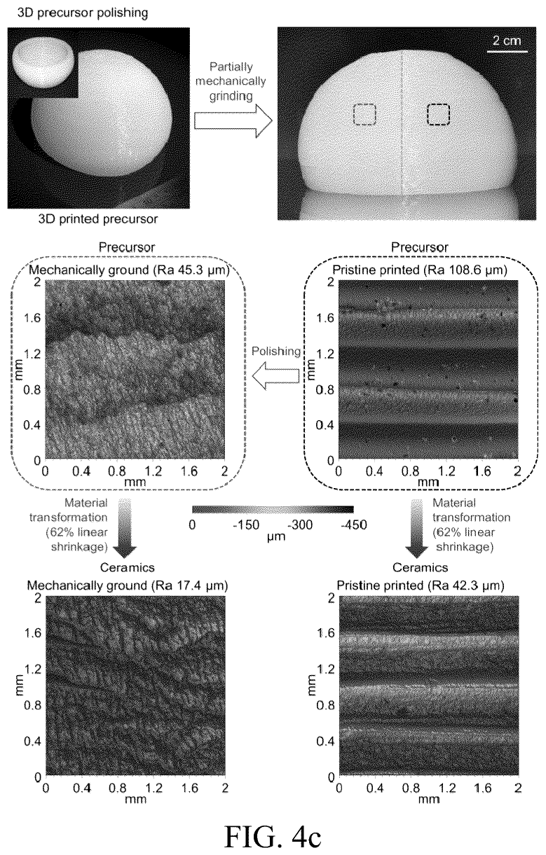

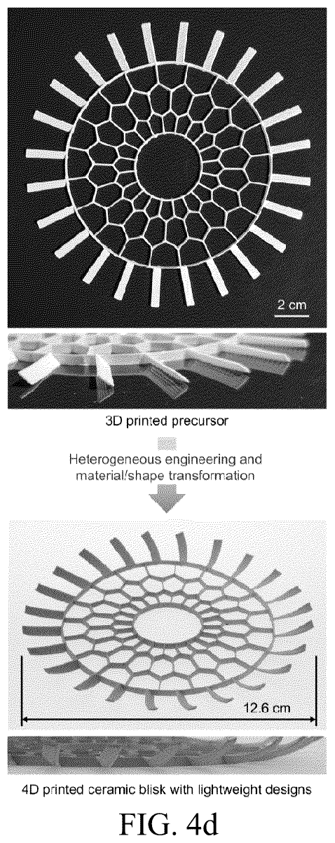

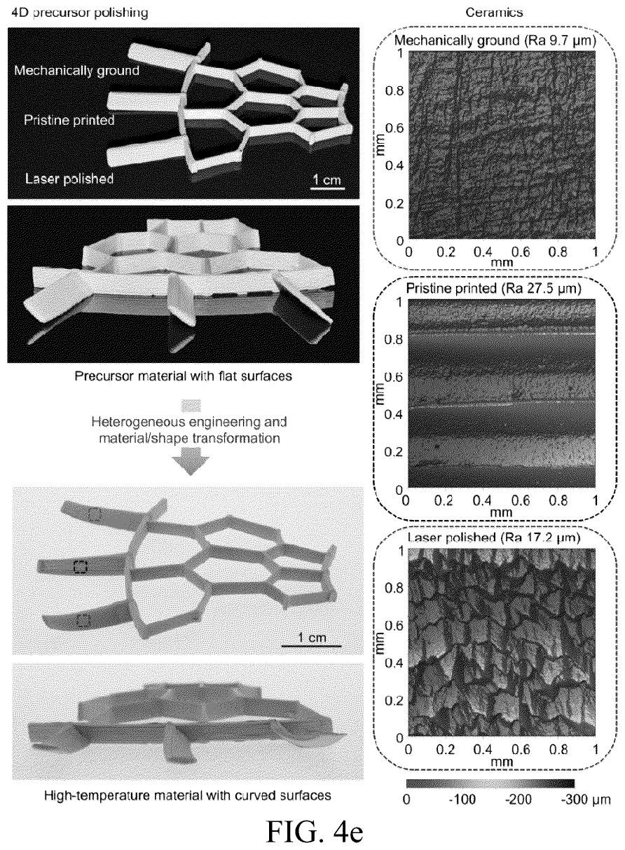

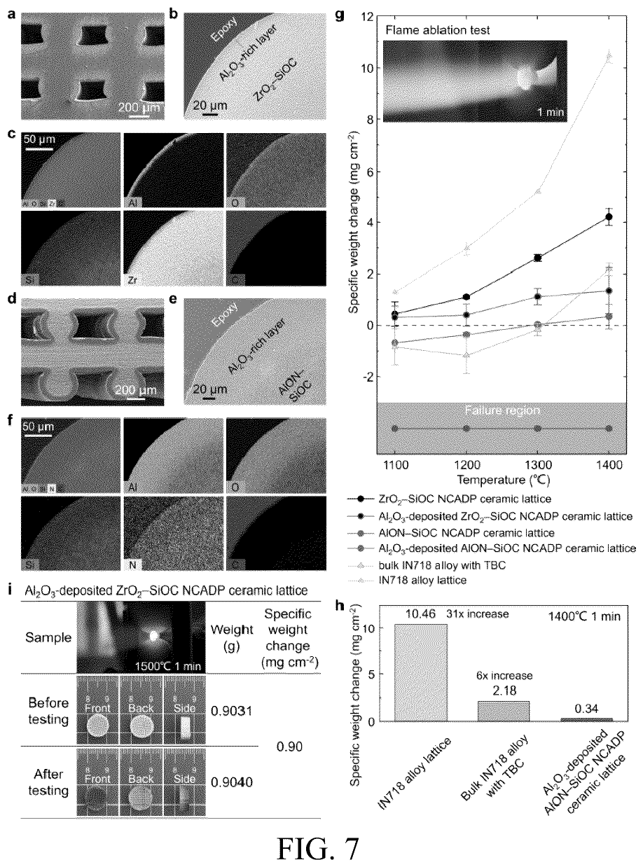

Moreover, the simple structure of precursors can facilitate the precision machining of high-temperature materials with complex shapes, such as by 4D precursor polishing (FIGS. 4a to 4e). Second, ceramic materials exhibit a low density, high hardness, and excellent thermal performance (FIG. 7) and can operate at higher turbine inlet temperatures (higher than 1300° C.) with lower cooling air requirements and higher combustion efficiencies than those associated with conventional high-temperature alloys. Thus, the use of the all-ceramic blisk can help increase the engine thrust-to-weight ratio and overall efficiency in an environmentally friendly manner while decreasing the fuel consumption. Third, the integrated shaping of the blisk can decrease the assembly time and lifecycle costs and enable better control of the clearances between parts of the propulsion system (FIG. 2), thereby decreasing the vibration, wear, and noise resulting from assembly deviations.

### [2D Surface Quality-Hybrid Manufacturing System of Subtractive Manufacturing and In Situ 4D Printing]

In some specific embodiments, precursor subtractive manufacturing and in situ 4D printing techniques are applied to post-treatment of additive manufactured (e.g., 3D printed) structures to solve step effects caused by layer-by-layer additive manufacturing. High-energy beams or mechanical grinding tools may be used for surface polishing to eliminate the step effects of 3D printed precursor materials. FIGS. 4a to 4e show photographs of 2D/3D/4D precursor polishing, wherein FIG. 4a is precursor polishing strategy; FIG. 4b, the PLE method was used for polishing a printed flat ceramic precursor material with the stair-step effect; FIG. 4c, mechanical grinding was performed for polishing a printed ceramic precursor material with a hyper-hemispherical dome structure, resulting in surface polishing of 3D printed ceramic structures through polymer-to-ceramic transformation; FIG. 4d, 4D printing and integrated shaping for a large-scale all-ceramic blisk with lightweight designs; FIG. 4e, 4D printing for polishing complex-shaped ceramic blades with curved surfaces.

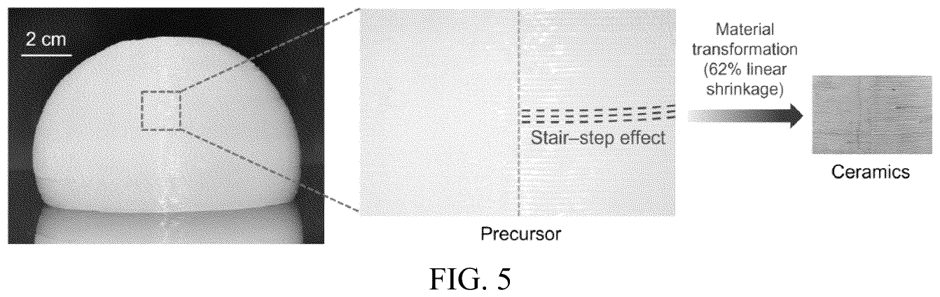

The subtractive manufacturing of precursors and in situ 4D printing technique can be applied in the post-processing of printed structures to address stair-step effect resulting from layer-wise AM. High-energy beams or mechanical grinding tools can be used for surface polishing and eliminating the stair-step effect of 3D printed precursor materials. In this manner, smoother surfaces of similar or deformed structures can be obtained upon shrinkage during material transformation to high-temperature materials (FIG. 4a). The surface roughness (Ra) of a printed 2D structure of the ceramic precursor was 16.5 μm, and it decreased by 44% (to 9.2 μm) after laser polishing (FIG. 4b). In addition, the surface quality of a 3D printed hyper-hemispherical dome was enhanced by 84% (from Ra=108.6 μm to 17.4 μm) owing to the mechanical grinding of its precursor and uniform linear shrinkage accompanying polymer-to-ceramic transformation (FIG. 4c and FIG. 5).

In some specific embodiments, the integration of precursor polishing and 4D morphing provides a new route to prepare high-surface-quality high-temperature materials with complex shapes. For example, the polishing of the flat surface of the blades in a blisk is easier than polishing curved surfaces. The surface roughness of the curved blade was decreased by 65% and 37% through mechanical grinding and laser polishing, respectively (FIG. 4d, 4e), which can help extend the lifespan of turbine blades.

### [Additive-Subtractive Manufacturing System]

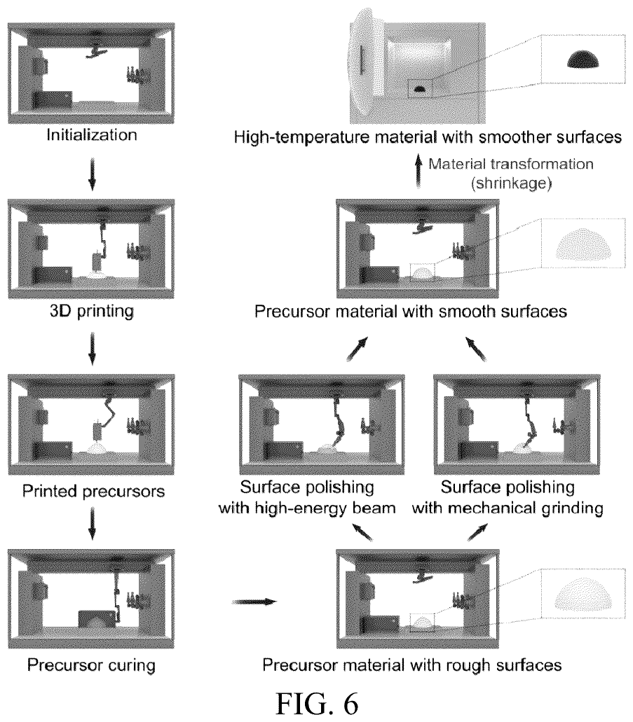

In some specific embodiments, the concept of 2D/3D/4D precursor polishing can be integrated with the AM process to form an ASM system (FIG. 6). Compared with the system involving a separate AM process for the precursor and precursor polishing, the integrated system can more efficiently and precisely manufacture high-temperature structural materials with high surface quality, as the 3D architectural features can be directly and precisely shared by the additive and subtractive manufacturing processes. The advantages of the hybrid system are more notable for products with higher geometrical complexity.

### [Thermal Performance]

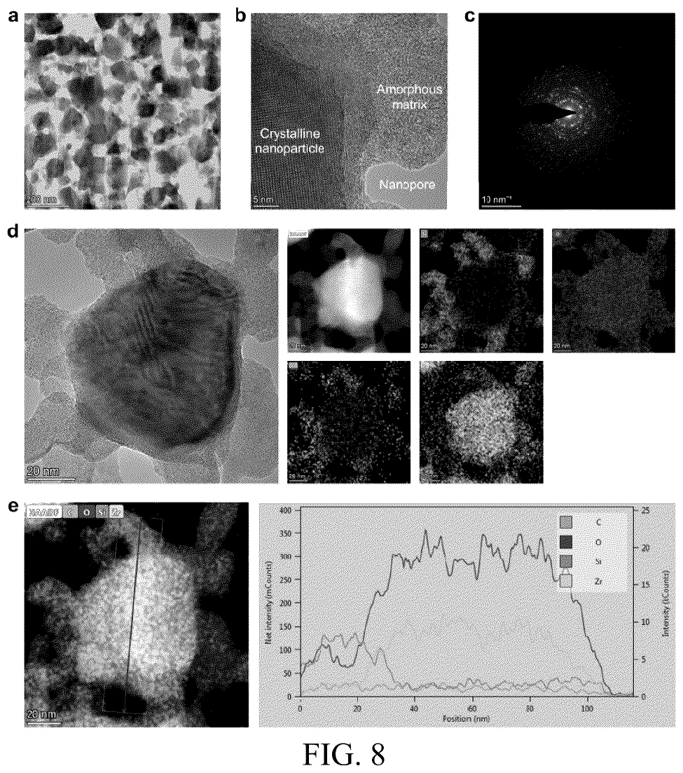

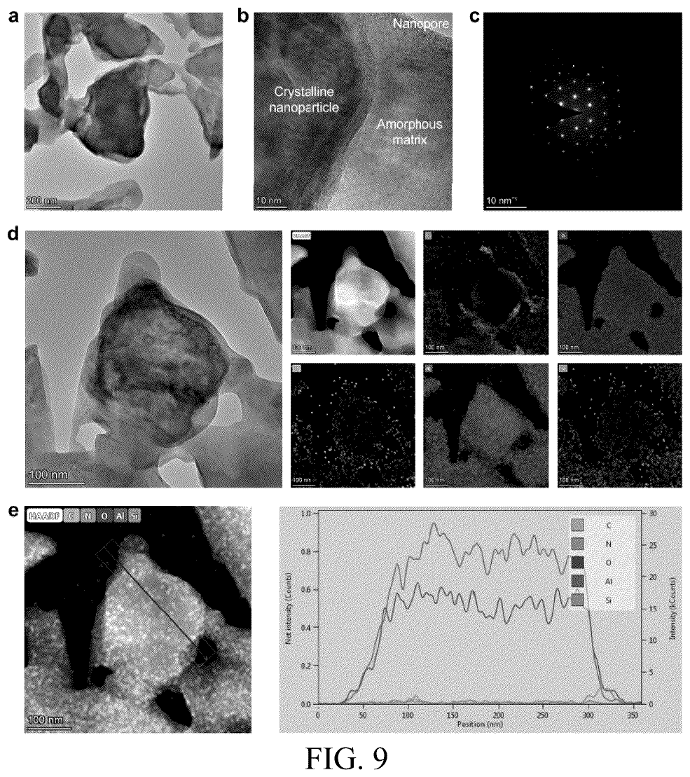

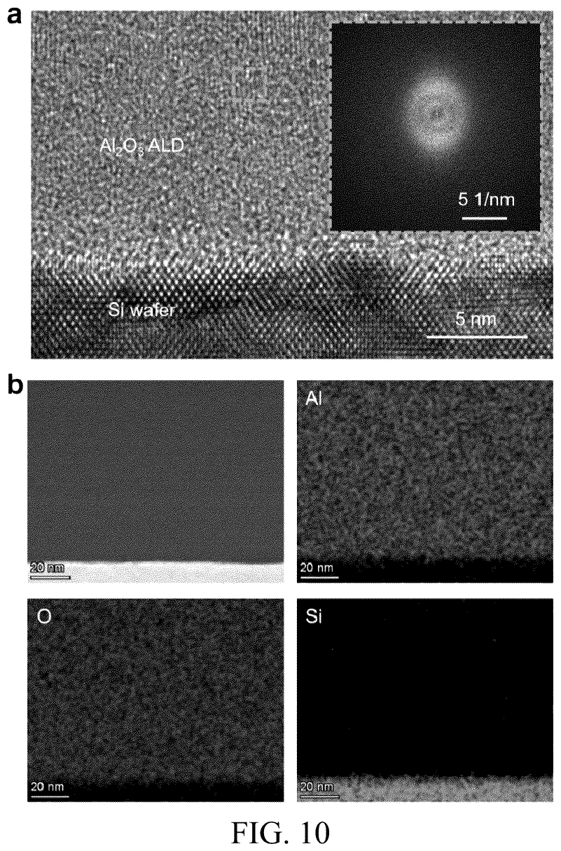

The ink system in the DIW technique can be easily tuned, which leads to considerable flexibility in terms of the material selection and performance optimization for high-temperature applications (FIG. 7). Consequently, the material performance can be tailored in terms of thermal and mechanical aspects. In some examples, the 3D printed ceramic lattices possessed ZrO₂—SiOC or AlON—SiOC NCADP structures with nanopores (FIGS. 8, 9). Through the atomic layer deposition (ALD) of amorphous Al₂O₃ (FIG. 10), an Al₂O₃-rich layer was uniformly formed on the surface of the printed ligaments in the interior of ceramic lattices. This evenness is challenging to achieve using physical vapor deposition (PVD).

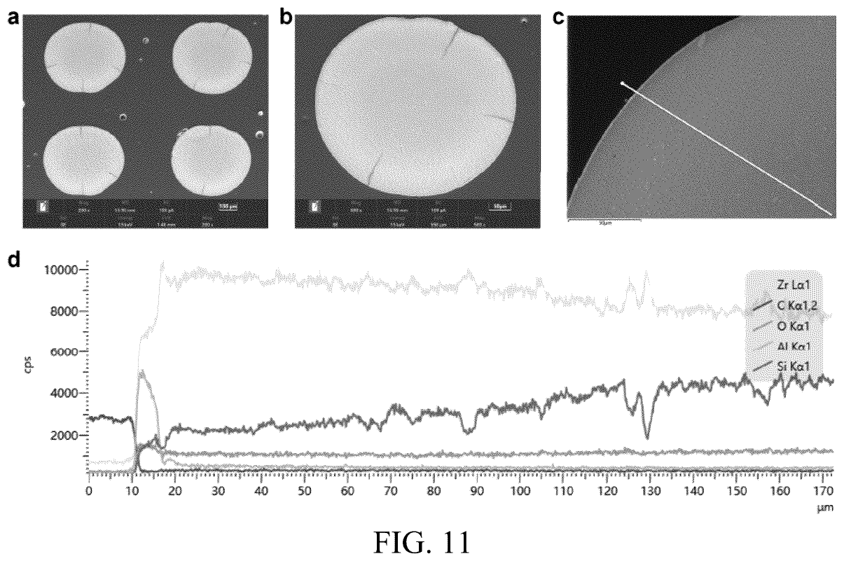

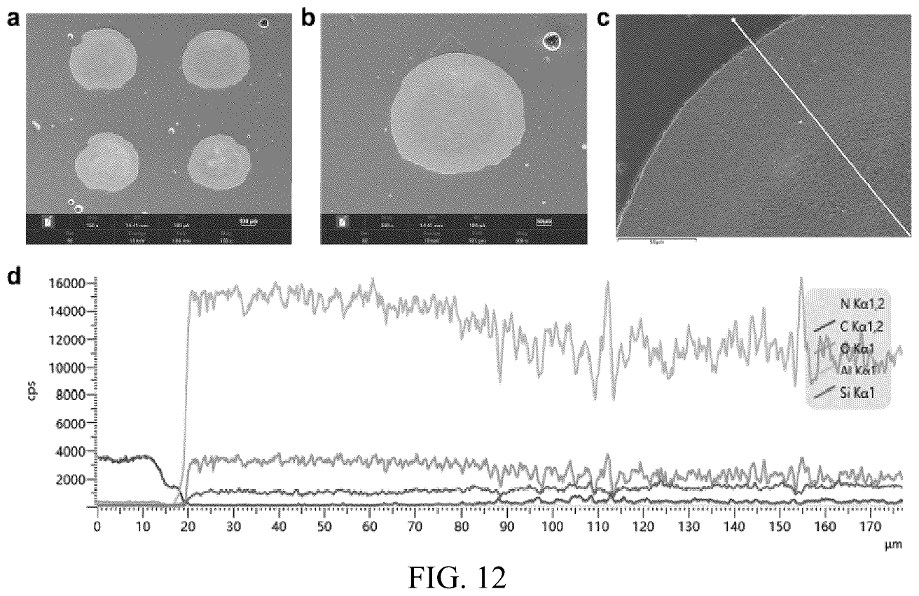

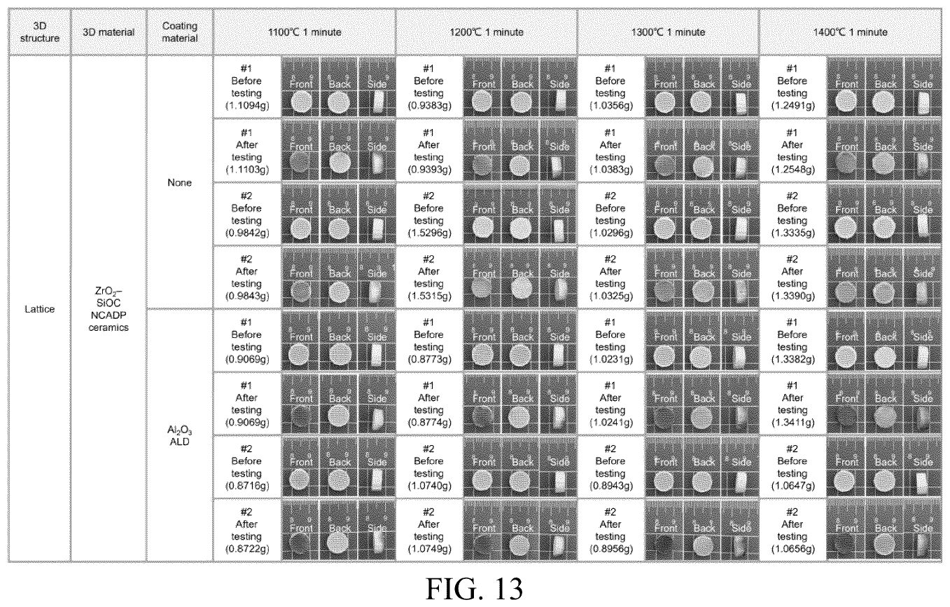

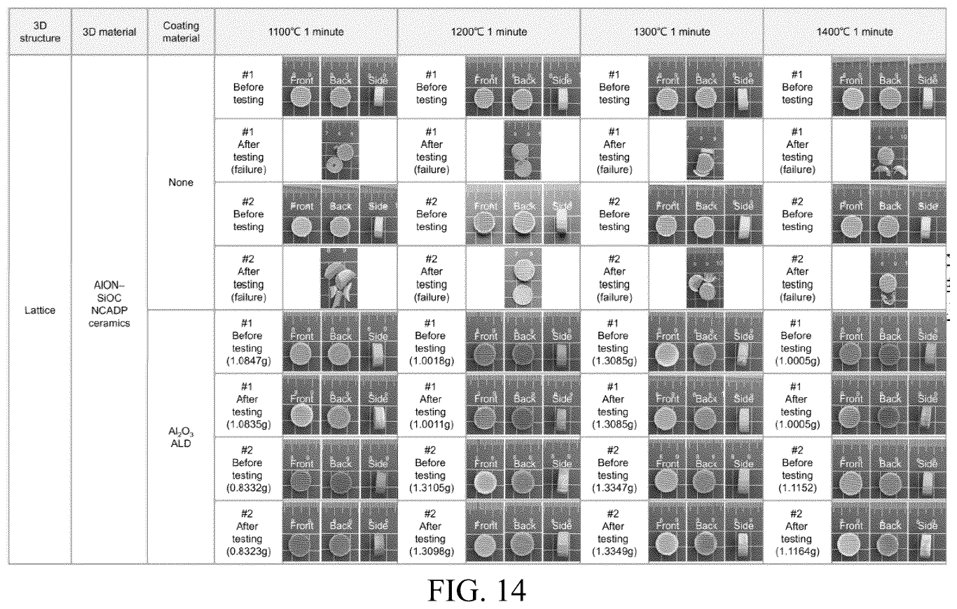

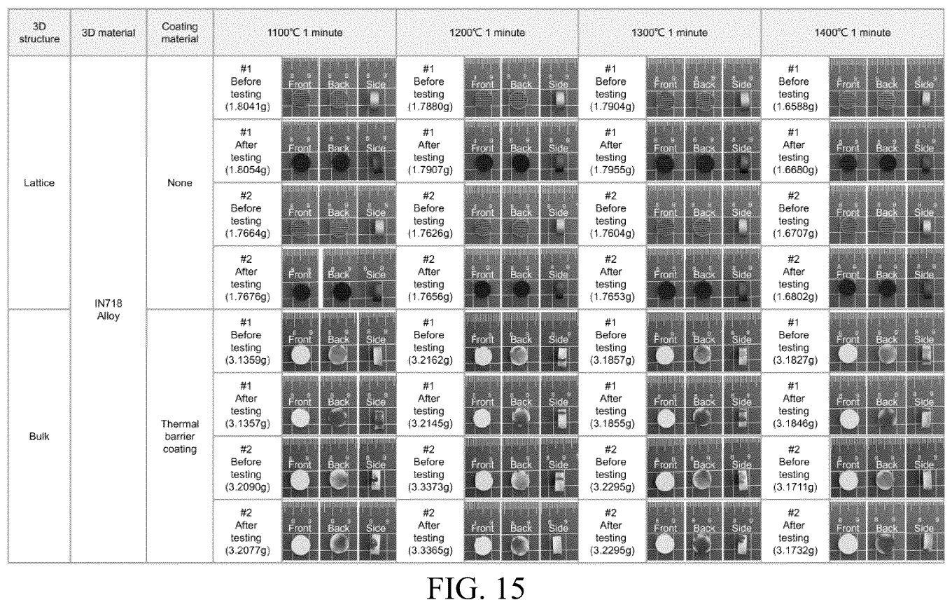

The resulting Al₂O₃-deposited ZrO₂—SiOC (FIG. 7 panel a to panel c, FIG. 11) and AlON—SiOC (FIG. 7 panel d and panel f, FIG. 12) ceramic lattices exhibited significantly higher flame ablation performance than their counterparts not subjected to ALD, and the specific weight changes at 1400° C. (1 minute application) were 97% lower than those of IN718 alloy lattices (FIG. 7 panel g, panel h, FIGS. 13-15 and Table 1). Moreover, Al₂O₃-deposited NCADP ceramic lattices exhibited a flame ablation performance (1400° C., 1 minute application) that was six times higher than that of the typical thermal barrier coating (TBC)-enhanced bulk IN718 alloy. The average density of the prepared ceramic lattices was 1.2-1.9 g cm-3, 16%-25% that of the TBC-enhanced bulk IN718 alloy (FIG. 7 panel h, Table 1). The printed Al₂O₃-deposited ZrO₂—SiOC NCADP ceramics maintained their lattice structure with a limited specific weight change (0.9 mg/cm²) at temperatures as high as 1500° C. (FIG. 7 panel i). Furthermore, mechanical properties of 4D printed ceramic architectures can be anticipated owing to their NCADP structures.

FIG. 9 is an NCADP structure of printed AlON—SiOC ceramic lattice, wherein FIG. 9 panel a is a transmission electron micrograph; FIG. 9 panel b is a high-resolution transmission electron micrograph; FIG. 9 panel c is SAED results; FIG. 9 panel d is EDS mapping analysis; FIG. 9 panel e is EDS line scan analysis and curves of net intensity and intensity of an element at different positions.

### [Second Method for Manufacturing Ceramic/Metal Component]

As described above, the present disclosure also discloses a method for manufacturing a ceramic/metal component, which comprises one of the following two modes: Mode I, comprising:
Ia) manufacturing or producing a ceramic-based object and a metal object, respectively; and
iIa) manufacturing a ceramic/metal component from the ceramic-based object and the metal object in the step Ia); and

Mode II, comprising:
Ib) manufacturing a ceramic-based object; and
iIb) then casting a metal material into a structure of the ceramic-based object, and assembling the metal material and the ceramic-based object to manufacture a ceramic/metal component.

For Mode I, the ceramic-based object is a printed ceramic coating. The printed ceramic coating may be manufactured in a manner known in the prior art or in a manner as defined in the present disclosure for manufacturing the ceramic component.

In Mode I, a ceramic/metal component is manufactured, wherein an interior of the component is a metal object, and an exterior of the component is a ceramic-based object; the metal object and the ceramic-based object are assembled together, and the assembly of the metal object and the ceramic-based object is achieved according to a difference of thermal expansion coefficients of the metal object and the ceramic-based object; specifically, as shown in FIG. 17 panel b, a ceramic/metal turbine blade is manufactured, wherein an interior of the blade is a high-temperature alloy object, and an exterior thereof is a ceramic coating; the high-temperature alloy object and the printed ceramic coating are assembled together, and an assembly of the high-temperature alloy object and the printed ceramic coating is achieved according to a difference of thermal expansion coefficients of the high-temperature alloy object and the printed ceramic coating.

For Mode II, in the step Ib), a ceramic-based object is manufactured in a manner known in the prior art or in a manner as defined in the present disclosure for manufacturing a ceramic component.

In Mode II, as shown in FIG. 17 panel c, a ceramic-based object is obtained through an additive-manufacturing process, then a molten nickel-based alloy is cast in the structure of the ceramic-based object, and after the molten nickel-based alloy is solidified, the molten nickel-based alloy and the ceramic-based object are assembled, and thus the ceramic/metal component is directly constructed.

### [Ceramic Component and Ceramic/Metal Component]

As described above, the present disclosure also provides a ceramic component or a ceramic/metal component manufactured by the method described above.

The ceramic component or the ceramic/metal component manufactured in the present disclosure has low density, high hardness and excellent thermal performance (FIG. 7) and can operate at higher turbine inlet temperatures (above 1300° C.). Compared with the traditional high-temperature alloy, the requirement on cooling air is lower, and the combustion efficiency is higher.

In some specific embodiments, the ceramic component may be a full ceramic aerospace turbine blisk. Specifically, a structure of the full ceramic aerospace turbine blisk can achieve a lightweight design by the method of the present disclosure.

In some specific embodiments, the ceramic component has a 4D printed ceramic structure, or the ceramic/metal component has a 4D printed ceramic/metal composite structure.

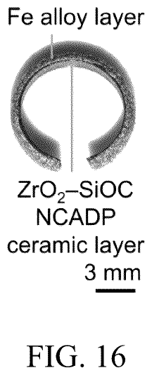

FIG. 16 shows a 4D printed ceramic/metal composite structure printed using multiple materials including ceramic and metal precursors. The composite material and structural heterogeneity can be obtained in the process of printing using multiple materials.

In some specific embodiments, the use of the full ceramic aerospace turbine blade disk (i.e., blisk) of the present disclosure may help to increase the thrust-weight ratio and overall efficiency of an engine in an environmentally friendly manner while reducing oil consumption.

In addition, through the integrated molding of the blisk, assembly time and cycle costs may be reduced, and clearances between components of the propulsion system (FIG. 2) may be better controlled, thereby reducing vibration, wear and noise caused by assembly variations.

### [Ceramic/Metal Composite Structure]

In some specific embodiments, the ceramic/metal object has a composite structure. Specifically, the composite structure is a ceramic/metal composite structure in a turbine blade for aerospace applications.

In some specific embodiments, the composite structure comprises an assembly of a printed ceramic precursor coating and an Ni-based alloy turbine blade by wrapping, an assembly of a printed ceramic coating and an Ni-based alloy turbine blade by wrapping, and casting of an Ni-based alloy into a printed ceramic turbine blade.

FIG. 16 shows 4D printed ceramic/metal composite structure using multimaterial printing of ceramic and metal precursors. Multimaterial printing is performed to generate such composite materials and structural heterogeneity. Furthermore, ceramic/metal composite structures for aerospace application in the turbine blade can also be achieved using the paradigm of 3D/4D additive-subtractive manufacturing strategies, including assembly of printed ceramic precursor coatings, assembly of printed ceramic coatings and Ni-based alloy turbine blade by wrapping, and Ni-based alloy turbine blade by wrapping, and casting of Ni-based alloy into printed ceramic turbine blade (FIG. 17).

FIG. 17 is a schematic diagram of a ceramic/metal composite structure of the present disclosure in the manufacture of a turbine blade for aerospace applications. In FIG. 17 panel a, the assembly of a printed ceramic precursor coating and a nickel-based alloy turbine blade is achieved. In FIG. 17 panel b, the assembly of a printed ceramic coating and a nickel-based alloy turbine blade is achieved. In FIG. 17 panel c, the assembly is achieved by casting a nickel-based alloy into a printed ceramic structure.

### [Atomic Layer Deposition]

In the present disclosure, a ceramic coating material is deposited on a ceramic surface of the ceramic component or the ceramic/metal component by using atomic layer deposition to enhance high-temperature performance.

The ink system in the DIW technique can be easily tuned, which leads to considerable flexibility in terms of the material selection and performance optimization for high-temperature applications (FIG. 7). Consequently, the material performance can be tailored in terms of thermal and mechanical aspects. In some examples, the 3D printed ceramic lattices possessed ZrO₂—SiOC or AlON—SiOC NCADP structures with nanopores (FIGS. 8, 9).

In some specific embodiments, the ceramic coating material may be, for example, Al₂O₃. Specifically, the present disclosure provides a method for enhancing high-temperature performance by atomic layer deposition (ALD) of amorphous Al₂O₃, as shown in FIG. 10.

Through the atomic layer deposition (ALD) of amorphous Al₂O₃ (FIG. 10), an Al₂O₃-rich layer was uniformly formed on the surface of the printed ligaments in the interior of ceramic lattices. This evenness is challenging to achieve using physical vapor deposition (PVD).

The resulting Al₂O₃-deposited ZrO₂—SiOC (FIG. 7 panel a to panel c, FIG. 11) and AION-SiOC (FIG. 7 panel d to panel f, FIG. 12) ceramic lattices exhibited significantly higher flame thermal-ablation performance than their counterparts not subjected to ALD, and the specific weight changes at 1400° C. (1 minute application) were 97% lower than those of IN718 alloy lattices (FIG. 7 panel g, panel h, FIGS. 13-15 and Table 1). Moreover, Al₂O₃-deposited NCADP ceramic lattices exhibited a flame thermal-ablation stability (1400° C., 1 minute application) that was six times higher than that of the typical thermal barrier coating (TBC)-enhanced bulk IN718 alloy. The average density of the prepared ceramic lattices was 1.2-1.9 g cm-3, 16%-25% that of the TBC-enhanced bulk IN718 alloy (FIG. 7 panel h, Table 1). The printed Al₂O₃-deposited ZrO₂—SiOC NCADP ceramics maintained their lattice structure with a limited specific weight change (0.9 mg/cm²) at temperatures as high as 1500° C. (FIG. 7 panel i). Furthermore, mechanical properties of 4D printed ceramic architectures can be anticipated owing to their NCADP structures.

### [Application Perspectives]

As described above, the ceramic component or the ceramic/metal component of the present disclosure has an extremely wide application field, and can be applied to the aerospace or other high-temperature fields. Specifically, it can be applied to shape memory and reconfigurable ceramics for morphing thermal protection systems, space origami systems, on-orbit manufacturing and repair, in situ space printing and colonization.

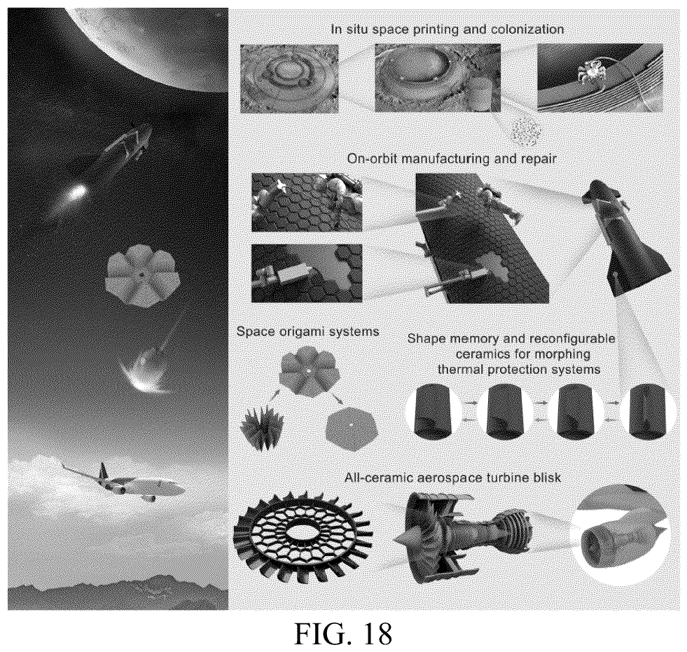

The proposed approach can ensure high scalability (16 cm), high resolution (6 μm), ultrafast transformation to high-temperature materials (in several seconds), and rapid manufacturing of precursor materials (mass production capability). The concept of 2D/3D/4D precursor polishing with versatile high-energy beam and mechanical grinding tools was developed for the first time to obtain high-surface-quality high-temperature materials. Furthermore, the proposed paradigm can be applied to ceramic, glass, metal, and composite materials, unlike the existing strategies that are typically limited to one or two types of high-temperature materials. Thus, the study can broaden the application scope of high-temperature structural materials in the aerospace and other fields (FIG. 18).

The concept of in situ 4D printing can be applied in space exploration, for instance, in morphing thermal protection systems (FIG. 18). Specifically, 4D printed shape memory and reconfigurable ceramics can help enhance the flexibility of the thermal protection system of a reentry vehicle/capsule. Using real-time measured data, an optimized and reliable thermal protection system with shape-morphing capabilities can be 4D printed in situ to address the shape-related uncertainties and variable thermal environments encountered by reentry vehicle/capsules owing 11 to various factors such as ablation and complex flow effects. The lightweight design is preferable over the traditional design of heavy thermal shields to increase the payload and decrease the cost.

The proposed concept can be used in space for the on-orbit manufacturing of ultra-high-performance turbine blades or the on-orbit repair (such as additive remanufacturing) of heat shields and other essential parts that may fail in a long-term mission (FIG. 18). The manufacturing and repair based on the proposed technique is more rapid and less expensive than the traditional techniques, as the placement of ultra-scale-scale components in orbit or beyond is typically prohibitively expensive. The proposed 4D printing concept can also be applied for in situ space printing and colonization (FIG. 18). In general, the ability to manufacture locally using local materials is key for colonizing any location in space.

Certain exemplary embodiments will now be described to provide an overall understanding of the structure, function, manufacture, and use principle of the component and manufacturing method therefor disclosed herein. One or more of these embodiments are illustrated in the drawings. Those skilled in the art will understand that the devices and methods specifically described herein and illustrated in the drawings are non-limiting exemplary embodiments. The features illustrated or described in connection with one exemplary embodiment may be combined with the features of other embodiments. Such modifications and variations are intended to be included within the scope of the present disclosure. Moreover, in the present disclosure, similarly-numbered components of various embodiments generally have similar features when those components have similar properties and/or serve similar purposes.

### Example

### Preparation of Materials for the Ceramic Materials

For the ceramic materials, the inks for the precursors shown in FIGS. 1, 2 and FIG. 4b consisted of ZrO₂ nanoparticles (Tong Li Tech Co. Ltd.) and poly(dimethylsiloxane) (PDMS, SE1700, Dow Corning). Either 10 wt % ZrO₂ nanoparticles were added to liquid PDMS and mixed using triple rollers mills (Exakt). Next, the ink was poured into a syringe and centrifuged. The ink for the precursors shown in FIG. 4c was silicone (DOWSIL™ Green Multiple Purpose Silicone Sealant). The ink for the precursors shown in FIG. 4d, 4e consisted of AlON nanoparticles (40 wt %) and PDMS (SE1700, Dow Corning). The ink for the precursors shown in FIG. 7 panel a consisted of ZrO₂ nanoparticles (20-50 nm, Tong Li Tech Co. Ltd., 58 wt %) and a mixture of 12 two types of PDMS (SE 1700 and Sylgard 184, Dow Corning). The ink for the precursors shown in FIG. 7 panel d consisted of AlON nanoparticles (50 wt %) and PDMS (SE1700, Dow Corning).

For the Fe alloy materials, the ink for precursors consisted of iron powder (5-9 μm, Strem Chemicals, Inc., 70 wt %) and cellulose (Shanghai Macklin Biochemical Co., Ltd.). The Fe alloys were obtained by heating the dried precursors to 800° C. for 2 hours and cooling the samples to ambient temperature in a resistance heating furnace with an argon flow of 200 mL min⁻¹. The heating and cooling rates were 5° C. min⁻¹ and 10° C. min⁻¹, respectively. The resultant Fe alloy had an average composition of Fe₄₅O₃₉C₁₆, measured by energy-dispersive X-ray spectroscopy (EDS).

### In Situ 4D Additive-Subtractive Manufacturing (ASM)

For the 4D printing and integrated shaping of the ceramic blisk, as shown in FIG. 2, a sample of an engine turbine disk (height of 6.4 mm, and inner and outer diameters of 40 mm and 16 mm, respectively) with 12 blades (24 mm×9 mm×0.4 mm) was 3D printed with the ink of PDMS/20 wt % ZrO₂. The surface of each blade was flat and intersected the ground at 45°. Next, each blade was selectively exposed to UV and ozone treatment for 16 hours by masking the surface with a laser-cut paper. The instrument for the UV and ozone treatment is an ultraviolet ozone cleaning machine available from Novascan Company, which has main wavelengths of 185 nm and 253.7 nm, and the ozone concentration is 250 ppm. Then, the prepared heterogeneous ceramic precursors were heated to 1000° C. for 2 hours, followed by cooling to ambient temperature under vacuum in a resistance heating furnace. The heating and cooling rates were 5° C. min-1 and 10° C. min-1, respectively.

### Flame Ablation Testing

Samples with cylindrical woodpile structure of the ceramic precursor material (cylinder diameter, 15 mm; cylinder height, 5.88 mm; nozzle diameter, 0.6 mm; layer thickness, 0.42 mm; center-tocenter ligament spacing, 1 mm) were 3D printed using DIW technique. The printed precursors were cured at 150° C. for 30 minutes in an oven, and then heated to 1300° C. for 2 hours, followed by cooling to ambient temperature under vacuum in a resistance heating furnace.

Samples with cylindrical woodpile structure of the IN718 alloy (cylinder diameter, 10.7 mm; cylinder height, 4.2 mm; ligament diameter, 0.3 mm; center-to-center ligament spacing, 0.71 mm) were 3D printed using selective laser melting technique.

For ALD process, stoichiometric Al₂O₃ thin films were deposited on 3D printed ceramics by using a homemade thermal ALD system. First, the cleaned ceramic specimens were placed in the reaction chamber, and the chamber was evacuated to a base pressure less than 0.3 Pa. Highpurity argon gas was used to purge the reaction chamber. The reaction chamber was heated at a rate of 1° C./min until the temperature stabilized at 180° C. To deposit the Al₂O₃ thin films, trimethylaluminum and water precursors were used as reactants, and argon was used as the carrier and purging gas. After the deposition, the reaction chamber was cooled in vacuum, and the treated specimens were extracted from the chamber by venting after the chamber temperature decreased to less than 50° C.

For TBC process, the superalloy IN718 samples were used as the substrate material. Commercial NiCrAlY powders (No. 9624, Sulzer-Metco) were used for bond coating. Agglomerated and sintered ZrO₂−7 wt. % Y₂O₃ (7YSZ) powders used for the top ceramic coating were provided by H.C. Starck (AMPERIT™ 827). Prior to bond coating, the substrates were degreased and cleaned with gasoline and ethanol, followed by grit blasting with alumina at a pressure of 0.2 MPa. Subsequently, the samples with bond and ceramic coatings were prepared using an atmospheric plasma spray (APS, MF-P1000, GTV, Germany). The thickness values of the bond and top ceramic coatings were approximately 50 and 80 μm, respectively.

For flame ablation testing process, the testing sample was fixed on the setup, with the front surface facing the flame gun. After ignition, high-temperature gas formed at the nozzle of the gas gun, and the gas gun advanced to heat the surface of the sample. The surface temperature of the sample was monitored in real time by using an infrared thermometer. When the sample temperature reached the target temperature, the heat preservation stage was initiated. In this stage, the system dynamically changed the gas flow through an automatic feedback adjustment system to maintain the temperature balance. After the heat preservation stage, the spray gun was withdrawn, and the sample surface was cooled by compressed air. The data point in FIG. 7 represents the average value obtained from two samples as shown in FIGS. 13-15 and Table 1. Table 1 shows flame ablation testing samples shown in FIG. 7.

TABLE 1

| | | | | | | | | | 1100° C. for 1 minute | | |
|---|---|---|---|---|---|---|---|---|---|---|---|
| | | | | | | | | | | | Average |
| | | | | | | | | | | Specific | specific |
| | | | | | | | | | | weight | weight |
| | | | | | | Average | | Average | Weight | change | change |
| 3 D | | Coating | Weight | Diameter | Height | height | Density | density | change | (mg | (mg |
| structure | 3 D material | material | (g) | (mm) | (mm) | (mm) | (g cm⁻³) | (g cm⁻³) | (%) | cm⁻²) | cm⁻²) |
| Lattice | ZrO₂—SiOC | None | 1.03 | 11.58 | 4.93 | 4.88 | 1.98 | 1.98 | 0.08 | 0.77 | 0.44 ± |
| | NCADP | | 1.10 | 11.83 | 4.83 | | 2.07 | | 0.01 | 0.10 | 0.48 |
| | Ceramics | | 0.94 | 11.39 | 4.87 | | 1.89 | | | | |
| | | Al₂O₃ | 0.92 | 11.40 | 4.94 | 4.84 | 1.82 | 1.86 | 0 | 0 | 0.311 ± |
| | | ALD | 0.90 | 11.39 | 4.72 | | 1.87 | | 0.07 | 0.63 | 0.44 |
| | | | 0.94 | 11.47 | 4.86 | | 1.87 | | | | |
| | AION—SiOC | None | 0.85 | 13.09 | 5.22 | 5.20 | 1.21 | 1.09 | Fail | Fail | Fail |
| | NCADP | | 0.75 | 13.10 | 5.17 | | 1.08 | | Fail | Fail | |
| | ceramics | | 0.67 | 12.80 | 5.22 | | 1.00 | | | | |
| | | Al₂O₃ | 0.72 | 12.50 | 5.15 | 5.21 | 1.14 | 1.18 | −0.11 | −0.68 | −0.68 ± |
| | | ALD | 0.77 | 12.56 | 5.18 | | 1.20 | | −0.11 | −0.68 | 0 |
| | | | 0.84 | 12.90 | 5.29 | | 1.21 | | | | |
| | IN718 | None | 1.77 | 10.78 | 4.60 | 4.59 | 4.23 | 4.12 | 0.05 | 0.95 | 0.95 ± |
| | Alloy | | 1.75 | 10.80 | 4.58 | | 4.18 | | 0.05 | 0.95 | 0 |
| | | | 1.67 | 10.82 | 4.60 | | 3.95 | | | | |
| Bulk | IN718 | Thermal | 3.16 | 10.92 | 4.52 | 4.60 | 7.45 | 7.35 | −0.02 | −0.68 | −0.51 ± |
| | Alloy | barrier | 3.13 | 10.98 | 4.58 | | 7.22 | | −0.01 | −0.34 | 0.24 |
| | | coating | 3.28 | 10.96 | 4.70 | | 7.39 | | | | |

| | | | 1200° C. for 1 minute | | | 1300° C. for 1 minute | | | 1400° C. for 1 minute | | |
|---|---|---|---|---|---|---|---|---|---|---|---|
| | | | | | Average | | | Average | | | Average |
| | | | | Specific | specific | | Specific | specific | | Specific | specific |
| | | | | weight | weight | | weight | weight | | weight | weight |
| | | | Weight | change | change | Weight | change | change | Weight | change | change |
| 3D | | Coating | change | (mg | (mg | change | (mg | (mg | change | (mg | (mg |
| structure | 3D material | material | (%) | cm⁻²) | cm⁻²) | (%) | cm⁻²) | cm⁻²) | (%) | cm⁻²) | cm⁻²) |
| Lattice | ZrO₂—SiOC | None | 0.11 | 1.06 | 1.11 ± | 0.26 | 2.51 | 2.61 ± | 0.46 | 4.45 | 4.21 ± |
| | NCADP | | 0.12 | 1.16 | 0.07 | 0.28 | 2.71 | 0.14 | 0.41 | 3.97 | 0.34 |
| | Ceramics | Al₂O₃ | 0.01 | 0.09 | 0.40 ± | 0.10 | 0.90 | 1.12 ± | 0.22 | 1.98 | 1.35 ± |
| | | ALD | 0.08 | 0.72 | 0.44 | 0.15 | 1.35 | 0.32 | 0.08 | 072 | 0.89 |
| | AION—SiOC | None | Fail | Fail | Fail | Fail | Fail | Fail | Fail | Fail | Fail |
| | NCADP | | Fail | Fail | | Fail | Fail | | Fail | Fail | |
| | ceramics | Al₂O₃ | −0.07 | −0.43 | −0.37 ± | 0 | 0 | 0.03 ± | 0 | 0 | 0.34 ± |
| | | ALD | −0.05 | −0.31 | 0.09 | 0.01 | 0.06 | 0.04 | 0.11 | 0.68 | 0.48 |
| | IN718 | None | 0.12 | 2.27 | 2.08 ± | 0.32 | 6.05 | 5.11 ± | 0.48 | 9.08 | 10.12 ± |
| | Alloy | | 0.10 | 1.89 | 0.27 | 0.22 | 4.16 | 1.34 | 0.59 | 11.16 | 1.47 |
| Bulk | IN718 | Thermal | −0.03 | −1.01 | −0.68 ± | 0.01 | 0.34 | 0 ± | 0.06 | 2.03 | 2.03 ± |
| | Alloy | barrier | −0.01 | −0.34 | 0.48 | −0.01 | −0.34 | 0.48 | 0.06 | 2.03 | 0 |
| | | coating | | | | | | | | | |

### Characterization

Transmission electron microscopy (TEM, Titan Themis 200/Strata 400S, FEI) analysis was performed to characterize the NCADP structure of ceramics. The focused ion beam (FIB, 450S/Talos F200, FEI) technique was used to prepare the TEM samples. Optical profiler measurements (NPFLEX, Bruker) were obtained for the laser-engraved samples to determine the 3D morphology.

The aforementioned description of the present disclosure is provided for purposes of illustration and description. It is not intended to be exhaustive or to limit the present disclosure to the precise form disclosed. Many modifications and variations will be apparent to those skilled in the art. These embodiments are chosen and described in order to better explain the principles of the present disclosure and its practical applications, to thereby enable others skilled in the art to understand the various embodiments of the present disclosure and the various modifications as are suited to the particular use contemplated. It is intended that the scope of the present disclosure and its equivalents be defined by the following claims.

1. A method for constructing a ceramic object by 4D printing, comprising:
1) constructing a precursor object using a precursor of a ceramic material;
2) converting the precursor object into a heterogeneous object by exposing one or more portions of the precursor object to UV and ozone, thereby changing a property of the one or more portions exposed to UV and ozone; and
3) converting the heterogeneous object into the ceramic object by a heat treatment, and during the heat treatment, the one or more portions exposed to UV and ozone and the remainder of the heterogeneous object which is not exposed to UV and ozone deform differently,
wherein the precursor of the ceramic material is selected from a polymer selected from poly(dimethylsiloxane) (PDMS) or silicone; or is selected from a composite consisting of a polymer matrix and a filler, wherein the polymer matrix is selected from poly(dimethylsiloxane) (PDMS) or silicone, and the filler is selected from ZrO₂, AlON, AlN, Al₂O₃, SiC, Si₃N₄, and mixtures thereof,
wherein the wavelength of the ultraviolet is 10-400 nm, preferably 100-350 nm, most preferably 170-270 nm;
wherein the concentration of the ozone is 10-10,000 ppm, preferably 50-5,000 ppm, more preferably 100-1,000 ppm, most preferably 200-300 ppm; and
wherein the time of UV and ozone exposure is 1-40 hours, preferably 2-30 hours, more preferably 3-20 hours, most preferably 8-16 hours.

2. The method according to claim 1, wherein the precursor object is manufactured in an additive manufacturing process;
or, the precursor object is manufactured by an additive manufacturing process in combination with at least one process selected from a subtractive manufacturing process and a surface engineering process.

3. The method according to claim 2, wherein the additive manufacturing process is selected from extrusion printing, blade coating, and combinations thereof;
or, the subtractive manufacturing process is selected from engraving, cutting, surface polishing, and combinations thereof;
or, the surface engineering process is selected from ultraviolet/ozone exposure, physical vapor deposition, chemical vapor deposition, atomic layer deposition, and combinations thereof.

4. The method according to claim 3, wherein the surface polishing is selected from 2D polishing, 3D polishing, 4D polishing, and combinations thereof.

5. The method according to claim 2, wherein the surface polishing is integrated with an additive manufacturing process to form an additive-subtractive manufacturing system for the ceramic object.

6. The method according to claim 2, wherein a tool used in the subtractive manufacturing process comprises a high-energy beam, a mechanical grinding tool, or combinations thereof.

7. The method according to claim 4, wherein the 4D polishing comprises polishing the precursor object prior to step 3), wherein the heat treatment in step 3) further reduces a surface roughness of the ceramic object.

8. The method according to claim 1, further comprising depositing a ceramic coating material on a surface of the ceramic object using atomic layer deposition, wherein the ceramic coating material is disposed in an interior of ceramic lattices of the ceramic object.

9. The method according to claim 8, wherein the ceramic coating material is Al₂O₃.
